(19) United States
(12) Patent Application Publication
(10) Pub. No.: US 2003/0135821 A1
(43) Pub. Date: Jul. 17, 2003

(54) On line presentation software using website development tools

(76) Inventor: Alexander Kouznetsov, Katy, TX (US)

Correspondence Address: Woodard, Emhardt, Naughton,, Moriarty and McNett LLP, Bank One Center/Tower, 111 Monument Circle, Suite 3700, Indianapolis, IN, 46204-5137, US

(21) Appl. No.: 10/346,541

(22) Filed: Jan. 17, 2003

Related U.S. Application Data
(60) Provisional application No. 60/349,878, filed on Jan. 17, 2002.

(51) Int. Cl. G06F 15/00

(52) U.S. Cl. 715/500

(57) ABSTRACT

A computer system is disclosed that provides a presentation software application that is easily migrated across multiple computing platforms and operating systems. The software produces presentations that are scalable to conform to the user's display and are portable between computers independent of the computer's operating systems. The application may be made available from a central server via a web link so that the application or enabling software does not have to reside on the user's computer.

### REFERENCE TO RELATED APPLICATIONS

This application claims priority from a Provisional Application Ser. No. 60/349,878, filed Jan. 17, 2002, which is hereby incorporated by reference.

### BACKGROUND OF THE INVENTION

The present invention relates to an internet-based presentation software application that permits users to create, edit, save, and play presentations, as well as send presentations to others.

Presentation software is the second most used office application after word processing. Although many presentations are shown to a captive audience at a single location, the cost and difficulty of travel is increasing the need for transportable presentations that may be sent to a variety of individuals operating on a variety of computing platforms.

Existing presentation software does not provide the level of portability that is needed in today's business environment. Microsoft® PowerPoint™ is the most popular presentation graphics software application in use today, but PowerPoint is limited to use on computers using the Microsoft Windows™ family of operating systems and a license for its use is relatively expensive to purchase. Additionally, PowerPoint presentations are not easily transferred via the internet as users must export the presentation to an internet-based format, such as HTML or XML, prior to uploading the presentation to a web server. Additionally, supporting media elements, such as sound clips or images, could be required to be exported as separate files, which can result in the presentation comprising a large number of files that must all be transferred, imported and assembled to reconstruct the original presentation. The recipient of the presentation must also be a PowerPoint licensee or have a PowerPoint player installed. Therefore there is a need for a presentation graphics software application that operates over multiple computing platforms as well as permits simple and efficient transfer of presentations over the internet.

### SUMMARY OF THE INVENTION

It is therefore an object of the present invention to provide a presentation graphics software application that seamlessly operates over multiple operating systems and computing platforms.

It is a further object of the invention to provide a presentation graphics software application that allows simple transportability of presentations over the internet.

It is a further object of the invention to provide a presentation graphics software application that can create presentations that may be limited to individual, particular distribution, or may be made available for widespread display via central storage on a web server.

These and other objects will become apparent from the illustrated drawing and the description of the embodiments.

### BRIEF DESCRIPTION OF THE DRAWING

FIG. 1 is a block diagram of a computer communications network in accordance the present invention.

### DESCRIPTION OF THE EMBODIMENTS

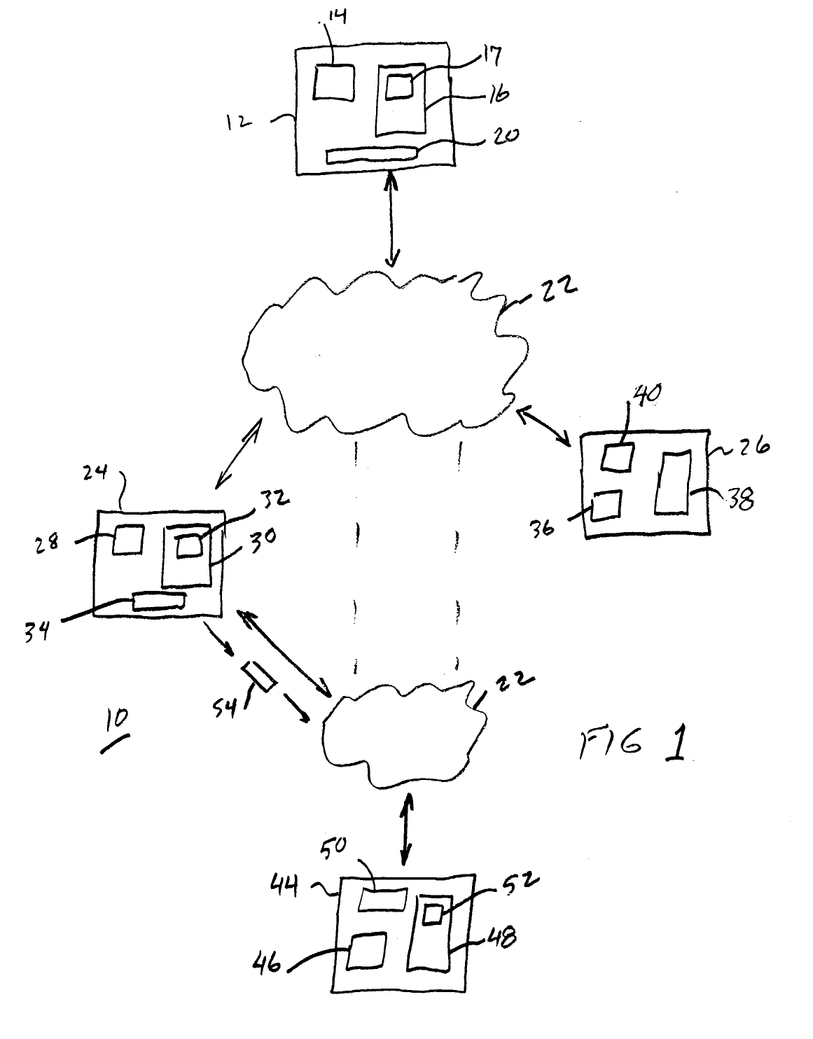

Referring to FIG. 1, there is shown a remote server-based computer system 10 that includes a central server 12. Server 12 may be of conventional design and is shown as including a processor 14, memory 16, and a presentation graphics software application in accordance with the present invention, designated as element 17. Server 12 is also shown as including a firewall 20. Individual users are connected to server 12 via the internet, designated as element 22 in FIG. 1. Server 12 is illustratively shown as being a single server, but may in practice be comprised of more than one device, such as a data server and a web server, for example. The number of individual users on system 10 at any given time may vary considerably, and may be quite large, but for illustration purposes, FIG. 1 shows individual users as represented by computers 24 and 26. Computers 24 and 26 may use the same operating system, or they may use different operating systems or computing platforms. Computer 24 is illustratively shown as including a processor 28, memory 30 and internet communications functionality 32, which may take a variety of forms, including a telephonic modem or a cable modem, for example. Computer 24 also includes the functionality of a presentation graphics software application in accordance with the present invention, designated in FIG. 1 as element 34. Similarly, computer 26 includes a processor 36, memory 38 and communications functionality 40 and could also optionally include presentation software as does computer 24, but this is not required, as more fully described below.

In one application, server 12 allows individual users, via computers 24 and 26, for example, to use server 12 as a network server on which various software applications and data are stored. These applications may include word processing and spread sheet analysis programs, for example, and a presentation graphics software application. Users of computers 24 and 26 may establish operative connection with server 12 via firewall 20 through internet connection 22. Documents and other materials created by remote users, such as users identified with computers 24 and 26, may also be stored on server 12 in a secure manner that protects against data loss should computer 24 or computer 26 fail or malfunction.

In accordance with a particular aspect of the present inventions, presentation software 17 of server 12, and presentation software 34 of computer 24, respectively, utilize Flash as their operating platform. Flash is a product of Macromedia, Inc. and is adapted to run on many computer platforms and operating systems, including Windows, Macintosh, Linux, Solaris, PocketPC, and others. By its use of Flash, the presentation software of the present invention permits ready portability of prepared presentations across different computing platforms and operating systems. In much the same way that other known presentation graphics applications are used, enabled users can create, edit, save, open, and display presentations. To create, edit or view presentations, all that is needed is a Flash player, which is available at no cost to users and is estimated to be installed on over 90% of the computers in use today. Some advantages in the presentation software application of the present invention that result from the use of Flash that are not typically available in other presentation software includes the ability to incorporate animated clipart (stand-alone animations within the presentation), a library of images and animated clipart that can be accessed and used, and animated text.

In accordance with additional aspects of the present invention, the presentation software application can operate without any presentation software being installed on the user's computer, such as is the case with the user of computer 26, for example. As it is a web-based application, only a browser, an internet connection and an authorization from server 12, which may be provided on a subscription basis, for example, is needed. Once connected to server 12, the presentation player is downloaded via a web browser for current use in managing (e.g., editing or viewing) presentations stored on server 12.

Presentations may be stored on server 12, but they may also be stored locally by users on their own computers. Presentations stored on server 12 may be in public or private folders. Presentations stored in private folders are then available to users having access to those folders, and presentations can be displayed from any computer connected to server 12, thereby eliminating the need to transport presentation software and presentation itself when a presentation is to be displayed at a remote location or at a third party's facility. Presentations stored in public folders may be made available to users for display and viewing via a website link or identified URL. A user who creates or edits a presentation, such as the user of computer 24, for example, may notify other users of server 12, such as the user of computer 26, for example, that a presentation has been made available for viewing. Authorization to allow other functions, such as editing, may also be provided. Computer 26 user may then, through an established connection with server 12 or through a web link, “share” (e.g., edit, view, etc.) the subject presentation created or edited by the user of computer 24. By transferring a presentation from a private to a public folder, an individual can effectively “publish” the presentation.

In accordance with another aspect of the present invention, users can also easily broadcast and transfer presentations to others, even if the recipients are not enabled to access server 12. A recipient not having access to server 12 is illustratively shown and identified as computer 44. Computer 44 is illustratively shown as comprising a processor 46, memory 48, and communications functionality 50. Computer 44 also optionally comprises presentation graphics software 52 as being previously installed (as is the case with computer 24), but the necessary software may be downloaded at the time a presentation is viewed (as is the case with computer 26). The recipient designated by computer 44 will only require whatever portion of software 52 that is needed for the recipient's function. For example, if the recipient is only authorized, or desires, to view presentations, the functionality of software 52 may be so limited. For recipients who desire to create their own presentations, or edit presentations that are sent to them, creation and editing functionality is required of software 52.

FIG. 1 illustrates, as an example, the transfer of a presentation 54 from computer 24 to the user of computer 44 by way of a connection via internet 22, which may be a simple email link, for example. If desired, the installed and authorized functionality of the users of computer 24 and/or computer 44 may allow interactive presentations. This functionality allows one or more users the capability to edit a presentation, or provide comments, while the presentation is being shown and managed by the presenter, which is tantamount to presenting a live presentation to all users at one time in one location. Users may interact with the presenter via audio, video, instant messaging, or a whiteboard, as examples, depending upon the functionality allowed by the presenter.

As described above, the software necessary to create, edit, and view presentations may be downloaded from server 12 at the time it is needed or it may be installed on a user's computer in advance.

As previously described, a desirable advantage of the presentation software of the present invention is the ability to store and transfer presentations as ordinary files. Presentation files may be stored on server 12, with server 12 being treated as a network server that provides data backup and disaster recovery capability, or they may be stored locally on the user's computer hard drive. Presentation files may also be posted on a presenter's web site with a web link being provided to permit access to the presentation. Access to, and the ability to create, edit, view, and broadcast presentation files is determined by whether the user has the necessary enabling software, which may be merely a web browser, and is authorized to perform such functions by the presenter. Such software can be provided by authorized download to the user's computer system, for example.

While the present invention has been illustrated in the drawing and described in detail in the foregoing description, it is understood that such illustration and description are illustrative in nature and are not to be considered restrictive, it being understood that only the preferred embodiments have been shown and described and that all changes and modifications that would be apparent or would occur to one skilled in the art are to be protected.

What is claimed is:

1. A system for creating, editing and displaying a computer-generated presentation comprising:
a central server;
presentation software residing on said central server, said presentation software utilizing software designed for website development;
a first computer remote from and operably connected to said central server;
connecting means for operably connecting said first computer with said central server; and
means for allowing said first computer to access said presentation software via said connecting means as if said presentation software resided on said first computer.

2. A method for managing a computer-generated presentation comprising the steps of:
accessing a first computer from a remote location by using a second computer;
utilizing website development software residing on said first computer to create, edit or display a presentation on said second computer; and
storing said presentation on said first computer.

3. A presentation software application comprising:
website development tools used for creation, editing and display of said presentation, said tools residing on a first computer;
means for accessing said tools from a remotely located second computer; and
means for utilizing said tools to manage a computer-generated presentation.
